(19) United States
(12) Patent Application Publication
(10) Pub. No.: US 2025/0211995 A1
(43) Pub. Date: Jun. 26, 2025

(54) APPARATUS, METHODS, AND COMPUTER PROGRAMS

(71) Applicant: Nokia Technologies Oy, Espoo (FI)

(72) Inventors: Mads LAURIDSEN, Aalborg (DK); Jeroen WIGARD, Aalborg (DK); Rafhael MEDEIROS DE AMORIM, Aalborg (DK); Jing Yuan SUN, Beijing (CN); Tzu-Chung HSIEH, Naperville, IL (US)

(21) Appl. No.: 18/850,688

(22) PCT Filed: Apr. 28, 2022
(86) PCT No.: PCT/CN2022/089955

§ 371 Date: Sep. 25, 2024

(51) Int. Cl. H04W 12/61; H04W 24/08; H04W 84/06

(52) U.S. Cl. CPC H04W 12/61; H04W 24/08; H04W 84/06

(57) ABSTRACT

An apparatus comprises means for monitoring uplink transmissions from a communications device to determine if the frequency and/or timing of the uplink transmissions are as expected and means for scheduling for the communications device a position acquisition gap when the frequency and/or timing of the uplink transmissions are not as expected.

### FIELD OF THE DISCLOSURE

The present disclosure relates to apparatus, methods, and computer programs and in particular, but not exclusively, to apparatus, methods and computer programs relating to position acquisition.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to an aspect, there is provided an apparatus comprising: means for monitoring uplink transmissions from a communications device to determine if the frequency and/or timing of the uplink transmissions are as expected; and means for scheduling for the communications device a position acquisition gap when the frequency and/or timing of the uplink transmissions are not as expected.

The apparatus may comprise means for causing a message to be sent to the communications device comprising information about the scheduled position acquisition gap.

The means for monitoring uplink transmissions from the communications device determines that the frequency and/or timing of the uplink transmissions are not as expected when the frequency and/or timing of the uplink transmissions differs from an expected frequency and/or timing for the uplink transmissions is greater than a threshold amount.

The apparatus may comprise means for causing a message to be sent to the communications device indicating that the communications device is to stop uplink transmissions until the communications device has reacquired a valid position.

Position acquisition may be by a global navigation satellite procedure, a network-based position procedure or a network-verified position procedure.

The apparatus may be a base station, a part of a base station or provided in a base station. The base station may be a gNB or the like. The apparatus may alternatively be provided in or be any other suitable network entity.

According to another aspect, there is provided an apparatus comprising: means for monitoring uplink transmissions from a communications device to determine if the frequency and/or timing of the uplink transmissions are as expected; means for determining that a position acquisition validity timer associated with the communications device is to expire; and means for, when it is determined the frequency and/or timing of the uplink transmissions are as expected and when it is determined that the position acquisition validity timer associated with the communications device is to expire, causing a message to be sent to the communications device indicating that the position acquisition validity timer associated with the communications device is to be restarted without performing a position acquisition fix.

The message may further comprise information indicating a new timing value for the position acquisition validity timer

Position acquisition may be by a global navigation satellite procedure, a network-based position procedure or a network-verified position procedure.

The apparatus may be a base station, a part of a base station or provided in a base station. The base station may be a gNB or the like. The apparatus may alternatively be provided in or be any other suitable network entity.

According to another aspect, there is provided an apparatus comprising: means for receiving from a network apparatus a message indicating that a position acquisition validity timer associated with a communications device is to be restarted without performing a position acquisition fix; and means for restarting the position acquisition validity timer without performing a position acquisition fix.

The means for restarting the position acquisition validity timer may restart the validity timer with a different timing value compared to the previous timing value.

The apparatus may comprise means for causing information to be transmitted to the network apparatus indicating a timing value which is being used for the restarted validity timer. The different timing value may be larger compared to the previous timing value.

The apparatus may comprise means for determining the different timing value in dependence on an elevation angle associated with a serving satellite of a non-terrestrial network.

The apparatus may comprise means for determining the different timing value based on a table of values stored said apparatus.

The apparatus may comprise means for determining the different timing value by incrementing the previous timing value by a fixed value to provide the different timing value.

The apparatus may comprise means for determining the different timing value by selecting a next value in a set of timing values.

Information about the different timing value may be provided by the network apparatus.

Position acquisition may be by a global navigation satellite procedure, a network-based position procedure or a network-verified position procedure.

The apparatus may be a communications device, a part of a communications device or provided in a communications device.

According to another aspect, there is provided an apparatus comprising: means for receiving from a network apparatus a message indicating the scheduling of a position acquisition gap; and means for performing a position acquisition fix in the position acquisition gap.

The apparatus may comprise means for stopping uplink communications with the network apparatus until a valid position has been reacquired.

Position acquisition may be by a global navigation satellite procedure, a network-based position procedure or a network-verified position procedure.

The apparatus may be a communications device, a part of a communications device or provided in a communications device.

According to an aspect there is provided an apparatus comprising at least one processor and at least one memory including computer code for one or more programs, the at least one memory and the computer code configured, with the at least one processor, to cause the apparatus at least to: monitor uplink transmissions from a communications device to determine if the frequency and/or timing of the uplink transmissions are as expected; and schedule for the communications device a position acquisition gap when the frequency and/or timing of the uplink transmissions are not as expected.

The at least one memory and the computer program code may be configured to, with the at least one processor, cause the apparatus at least to: cause a message to be sent to the communications device comprising information about the scheduled position acquisition gap.

The at least one memory and the computer program code may be configured to, with the at least one processor, cause the apparatus at least to: determine that the frequency and/or timing of the uplink transmissions are not as expected when the frequency and/or timing of the uplink transmissions differs from an expected frequency and/or timing for the uplink transmissions is greater than a threshold amount.

The at least one memory and the computer program code may be configured to, with the at least one processor, cause the apparatus at least to: cause a message to be sent to the communications device indicating that the communications device is to stop uplink transmissions until the communications device has reacquired a valid position.

Position acquisition may be by a global navigation satellite procedure, a network-based position procedure or a network-verified position procedure.

The apparatus may be a base station, a part of a base station or provided in a base station. The base station may be a gNB or the like. The apparatus may alternatively be provided in or be any other suitable network entity.

According to an aspect there is provided an apparatus comprising at least one processor and at least one memory including computer code for one or more programs, the at least one memory and the computer code configured, with the at least one processor, to cause the apparatus at least to: monitor uplink transmissions from a communications device to determine if the frequency and/or timing of the uplink transmissions are as expected; determine that a position acquisition validity timer associated with the communications device is to expire; and when it is determined the frequency and/or timing of the uplink transmissions are as expected and when it is determined that the position acquisition validity timer associated with the communications device is to expire, cause a message to be sent to the communications device indicating that the position acquisition validity timer associated with the communications device is to be restarted without performing a position acquisition fix.

The message may further comprise information indicating a new timing value for the position acquisition validity timer.

Position acquisition may be by a global navigation satellite procedure, a network-based position procedure or a network-verified position procedure.

The apparatus may be a base station, a part of a base station or provided in a base station. The base station may be a gNB or the like. The apparatus may alternatively be provided in or be any other suitable network entity.

According to an aspect there is provided an apparatus comprising at least one processor and at least one memory including computer code for one or more programs, the at least one memory and the computer code configured, with the at least one processor, to cause the apparatus at least to: receive from a network apparatus a message indicating that a position acquisition validity timer associated with a communications device is to be restarted without performing a position acquisition fix; and restart the position acquisition validity timer without performing a position acquisition fix.

The at least one memory and the computer program code may be configured to, with the at least one processor, cause the apparatus at least to: restart the validity timer with a different timing value compared to the previous timing value.

The at least one memory and the computer program code may be configured to, with the at least one processor, cause the apparatus at least to: cause information to be transmitted to the network apparatus indicating a timing value which is being used for the restarted validity timer.

The different timing value may be larger compared to the previous timing value.

The at least one memory and the computer program code may be configured to, with the at least one processor, cause the apparatus at least to: determine the different timing value in dependence on an elevation angle associated with a serving satellite of a non-terrestrial network.

The at least one memory and the computer program code may be configured to, with the at least one processor, cause the apparatus at least to: determine the different timing value based on a table of values stored said apparatus.

The at least one memory and the computer program code may be configured to, with the at least one processor, cause the apparatus at least to: determine the different timing value by incrementing the previous timing value by a fixed value to provide the different timing value.

The at least one memory and the computer program code may be configured to, with the at least one processor, cause the apparatus at least to: determine the different timing value by selecting a next value in a set of timing values.

Information about the different timing value may be provided by the network apparatus.

Position acquisition may be by a global navigation satellite procedure, a network-based position procedure or a network-verified position procedure.

The apparatus may be a communications device, a part of a communications device or provided in a communications device.

According to an aspect there is provided an apparatus comprising at least one processor and at least one memory including computer code for one or more programs, the at least one memory and the computer code configured, with the at least one processor, to cause the apparatus at least to: receive from a network apparatus a message indicating the scheduling of a position acquisition gap; and perform a position acquisition fix in the position acquisition gap.

The at least one memory and the computer program code may be configured to, with the at least one processor, cause the apparatus at least to: stop uplink communications with the network apparatus until a valid position has been reacquired.

Position acquisition may be by a global navigation satellite procedure, a network-based position procedure or a network-verified position procedure.

The apparatus may be a communications device, a part of a communications device or provided in a communications device.

According to an aspect, there is provided a method comprising: monitoring uplink transmissions from a communications device to determine if the frequency and/or timing of the uplink transmissions are as expected; and scheduling for the communications device a position acquisition gap when the frequency and/or timing of the uplink transmissions are not as expected.

The method may comprise causing a message to be sent to the communications device comprising information about the scheduled position acquisition gap.

The method may comprise determining that the frequency and/or timing of the uplink transmissions are not as expected when the frequency and/or timing of the uplink transmissions differ from an expected frequency and/or timing for the uplink transmissions is greater than a threshold amount.

The method may comprise causing a message to be sent to the communications device indicating that the communications device is to stop uplink transmissions until the communications device has reacquired a valid position.

Position acquisition may be by a global navigation satellite procedure, a network-based position procedure or a network-verified position procedure.

The method may be performed by an apparatus. The apparatus may be a base station, a part of a base station or provided in a base station. The base station may be a gNB or the like. The apparatus may alternatively be provided in or be any other suitable network entity.

According to another aspect, there is provided a method comprising: monitoring uplink transmissions from a communications device to determine if the frequency and/or timing of the uplink transmissions are as expected; determining that a position acquisition validity timer associated with the communications device is to expire; and when it is determined the frequency and/or timing of the uplink transmissions are as expected and when it is determined that the position acquisition validity timer associated with the communications device is to expire, causing a message to be sent to the communications device indicating that the position acquisition validity timer associated with the communications device is to be restarted without performing a position acquisition fix.

The message may further comprise information indicating a new timing value for the position acquisition validity timer

Position acquisition may be by a global navigation satellite procedure, a network-based position procedure or a network-verified position procedure.

The method may be performed by an apparatus. The apparatus may be a base station, a part of a base station or provided in a base station. The base station may be a gNB or the like. The apparatus may alternatively be provided in or be any other suitable network entity.

According to another aspect, there is provided a method comprising: receiving from a network apparatus a message indicating that a position acquisition validity timer associated with a communications device is to be restarted without performing a position acquisition fix; and restarting the position acquisition validity timer without performing a position acquisition fix.

The method may comprise restarting the validity timer with a different timing value compared to the previous timing value.

The method may comprise causing information to be transmitted to the network apparatus indicating a timing value which is being used for the restarted validity timer.

The different timing value may be larger compared to the previous timing value.

The method may comprise determining the different timing value in dependence on an elevation angle associated with a serving satellite of a non-terrestrial network.

The method may comprise determining the different timing value based on a table of values stored said apparatus.

The method may comprise determining the different timing value by incrementing the previous timing value by a fixed value to provide the different timing value.

The method may comprise determining the different timing value by selecting a next value in a set of timing values.

Information about the different timing value may be provided by the network apparatus.

Position acquisition may be by a global navigation satellite procedure, a network-based position procedure or a network-verified position procedure.

The method may be performed by an apparatus. The apparatus may be a communications device, a part of a communications device or provided in a communications device.

According to another aspect, there is provided a method comprising: receiving from a network apparatus a message indicating the scheduling of a position acquisition gap; and performing a position acquisition fix in the position acquisition gap.

The method may comprise stopping uplink communications with the network apparatus until a valid position has been reacquired.

Position acquisition may be by a global navigation satellite procedure, a network-based position procedure or a network-verified position procedure.

The method may be performed by an apparatus. The apparatus may be a communications device, a part of a communications device or provided in a communications device.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In another aspect there is provided a computer program embodied on a non-transitory computer-readable storage medium, the computer program comprising program code for providing any of the above methods.

In another aspect there is provided a computer program product for a computer, comprising software code portions for performing the steps of any of the previous methods, when said product is run.

A computer program comprising program code means adapted to perform the method(s) may be provided. The computer program may be stored and/or otherwise embodied by means of a carrier medium.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function
AMF: Access and Mobility Management Function
AUSF: Authentication Server Function
BS Base Station
CE Control element
CIoT: Cellular Internet of Things
CU: Centralized Unit
DCI: Downlink Control Information
DN: Data Network
DU: Distributed Unit
eMTC Enhanced machine type communication
GEO: Geostationary
gNB: gNodeB
GNSS: Global Navigation Satellite System
HARQ: Hybrid Automatic Repeat Request
IoT: Internet of Things
LEO: Low Earth Orbit
LTE: Long Term Evolution
MAC: Medium Access Control
MS: Mobile Station
MTC: Machine Type Communication
NB-IoT: Narrow Band Internet-of-Things
NEF: Network Exposure Function
NF: Network Function
NR: New radio
NRF: Network Repository Function
NTN: Non-Terrestrial Network
PSS: Primary Synchronization Signal
RAM: Random Access Memory
(R)AN: (Radio) Access Network
ROM: Read Only Memory
RRC: Radio Resource Control
SMF: Session Management Function
SSS: Secondary Synchronization Signal
TA: Timing Advance
TN: Terrestrial Network
TR Technical Report
TS: Technical Specification
UDM: User Data Management
UE: User Equipment
UMTS: Universal Mobile Telecommunication System
UPF: User Plane Function
WLAN: Wireless Local Area Network
WiMAX: Worldwide Interoperability for Microwave Access
WID: Work Item Description
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1a depicts an example of an architecture;

FIG. 1b shows a schematic representation of a 5G system;

FIG. 1c shows a schematic representation of a non-terrestrial network;

FIG. 2 shows a schematic representation of a control apparatus;

FIG. 3 shows a schematic representation of a user equipment;

FIG. 4 shows a graph of UE location error in m again TA error in μs;

FIG. 5 illustrates the signalling between a UE and the network according to some embodiments;

FIG. 6 shows a method flow of some embodiments;

FIG. 7 shows a first method performed by an apparatus;

FIG. 8 shows a second method performed by an apparatus;

FIG. 9 shows a third method performed by an apparatus;

FIG. 10 shows a fourth method performed by an apparatus; and

FIG. 11 shows a schematic representation of a non-volatile memory medium storing instructions which when executed by a processor allow a processor to perform one or more of the steps of the methods of FIGS. 7 to 10.

### DETAILED DESCRIPTION OF THE FIGURES

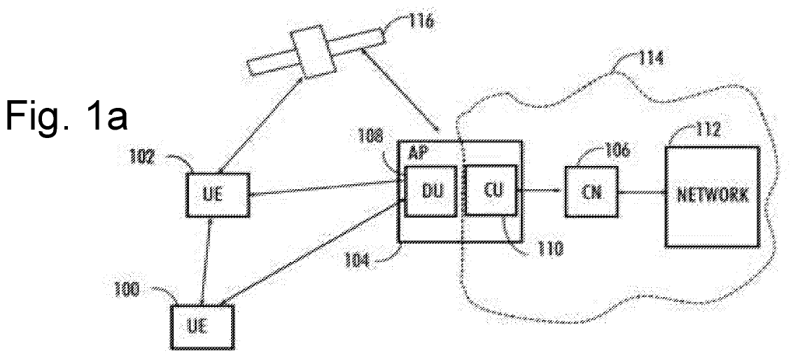

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1a, 1b, 1c, 2 and 3 to assist in understanding the technology underlying the described examples.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 1a depicts examples of simplified system architectures only showing some elements and functional entities, all being logical units, whose implementation may differ from what is shown. The connections shown in FIG. 1a are logical connections; the actual physical connections may be different. It is apparent to a person skilled in the art that the system typically comprises also other functions and structures than those shown in FIG. 1a.

The embodiments are not, however, restricted to the system given as an example but a person skilled in the art may apply the solution to other communication systems provided with necessary properties.

The example of FIG. 1a shows a part of an exemplifying radio access network. For example, the radio access network may support sidelink communications described below in more detail.

FIG. 1a shows devices 100 and 102. The devices 100 and 102 are configured to be in a wireless connection on one or more communication channels with a node 104. The node 104 is further connected to a core network 106. In one example, the node 104 may be an access node such as (e/g)NodeB serving devices in a cell. In one example, the node 104 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 106 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

A relay node may be provided. An example of a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1a) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cm Wave, 6 or above 24 GHz-cmWave and mm Wave).

One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1a by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or NodeB (gNB). It should be appreciated that MEC can be applied in 4G networks as well.

5G may also utilize satellite communication to enhance or complement the coverage of 5G service, for example by providing backhauling. An example satellite is referenced 116. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the device may have access to a plurality of radio cells and the system may comprise also other apparatuses, such as physical layer relay nodes or other network elements, etc. At least one of the (e/g)NodeBs or may be a Home (e/g)NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e/g)NodeBs of FIG. 1a may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g) Node Bs, includes, in addition to Home (e/g)NodeBs (H(e/g)NodeBs), a home node B gateway, or HNB-GW (not shown in FIG. 1a). A HNB Gateway (HNB-GW), which is typically installed within an operator's network may aggregate traffic from a large number of HNBs back to a core network.

FIG. 1b shows a schematic representation of a 5G system (5GS). The 5GS may comprises a terminal, a (radio) access network ((R)AN), a 5G core network (5GC), one or more application functions (AF) and one or more data networks (DN).

The 5G (R)AN may comprise a terrestrial network (TN) part wherein one or more gNB are located on one or more masts or towers. The 5G (R)AN may comprise a non-terrestrial network (NTN) part with transparent satellite based RAN architecture or with regenerative satellite based RAN architecture.

The concept of transparent architecture and regenerative architecture are defined in 3GPP TS 38.821. A satellite may implement a transparent architecture or payload. A transparent payload may only include radio frequency function, such as radio frequency filtering, frequency conversion and amplification. For the transparent architecture, one or more gNB may be located on the ground.

The regenerative satellite payload implements regeneration of the signals received from earth, i.e. transforms and amplifies an uplink radio frequency signal before transmitting it on the downlink. For the regenerative architecture, one or more gNB may be located on one or more satellites. In some situations part of the gNB (e.g. the DU) may be located on the satellite and part of the gNB (e.g. the CU) may be located on the ground.

The one or more gNB may comprise one or more gNB distributed unit functions connected to one or more gNB centralized unit functions.

The 5GC may comprise an access and mobility management function (AMF), a session management function (SMF), an authentication server function (AUSF), a user data management (UDM), a user plane function (UPF) and/or a network exposure function (NEF). The 5GC may comprise a gateway to the NTN part of the 5G (R)AN.

FIG. 1c illustrates an exemplary embodiment of a non-terrestrial network. A non-terrestrial network may refer to a network, or a segment of networks, using radio frequency, RF, resources in a satellite 150, or an unmanned aircraft system, UAS. The satellite 150, or UAS, may provide service, for example NR service, on Earth via one or more satellite beams and one or more cells 152, for example NR cells, over a given service area bounded by the field of view of the satellite 150. The beam footprints, i.e. the cells 152, may be elliptical in shape. There may be a service link 154, i.e. a radio link, between the satellite 150 and one or more UEs 156 within the targeted service area. The satellite may be configured to transmit one or more signals to the one or more UEs via the service link, and the one or more UEs may be configured to receive the one or more signals from the satellite. Furthermore, there may be a feeder link 156, i.e. a radio link, between the satellite 150 and one or more satellite gateways 160. The satellite gateway 160 may connect the satellite for example to a public data network 162. The satellite 150, the gateway 160, and/or the data network 162 may comprise base station functionalities, for example gNB functionalities, at least partially.

The satellite 150 may implement a transparent payload with radio frequency filtering, frequency conversion and amplification, wherein the waveform signal repeated by the payload is unchanged.

Alternatively, the satellite 150 may implement a regenerative payload with radio frequency filtering, frequency conversion and amplification, as well as demodulation and/or decoding, switch and/or routing, and coding and/or modulation. In other words, in the regenerative architecture, the satellite 150 may comprise all or at least some base station functionalities.

The satellite 150 may be, for example, in low Earth orbit at an altitude between 400 to 2000 km, as a non-limiting example. At such an altitude, the satellite may be moving at approximately 7.5 km/s relative to Earth. A UAS may operate for example at an altitude between 8 to 50 km, and it may be stationary or moving relative to the Earth.

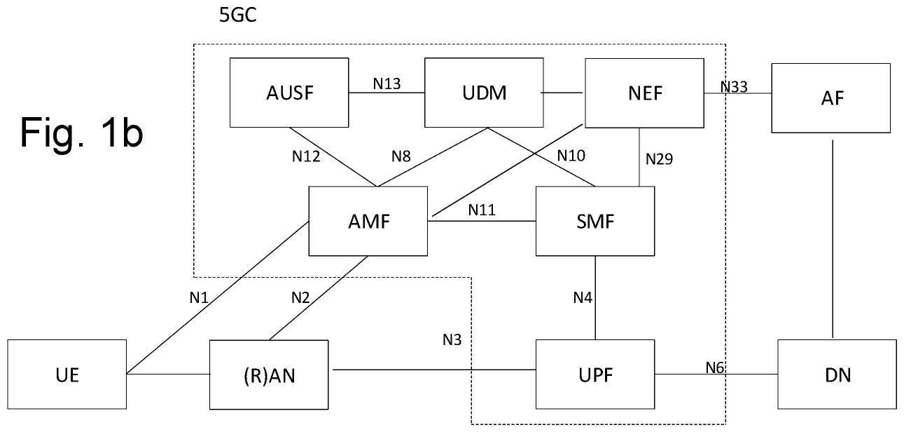

FIG. 2 illustrates an example of an apparatus 200. The apparatus may be a base station, a part of a base station or provided in a base station. The base station may be a gNB or the like. The apparatus may alternatively be provided in or be any other suitable network entity.

The apparatus may be a communications device, a part of a communications device or provided in a communications device.

The apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b.

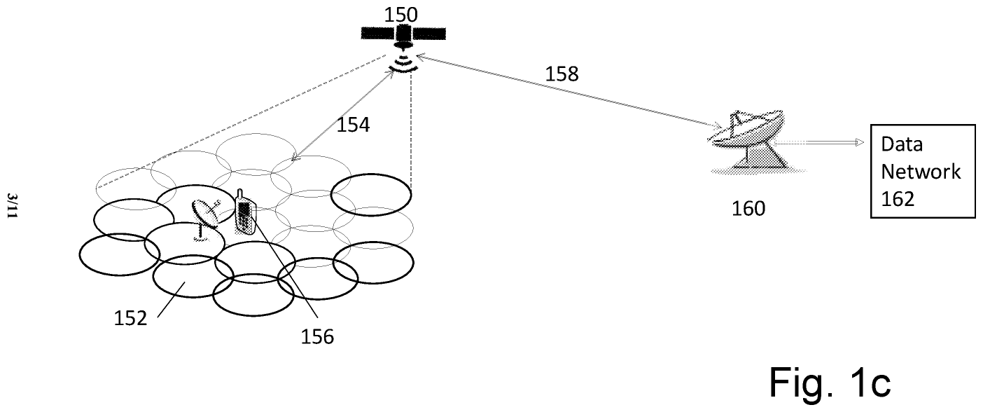

A possible communication device will now be described in more detail with reference to FIG. 3 showing a schematic, partially sectioned view of a communication device 300. The communication device 300 may be provided by any device capable of sending and receiving radio signals. The device typically refers to a mobile or static device (e.g. a portable or non-portable computing device) that includes wireless mobile communication devices operating with or without a universal subscriber identification module (USIM). Non-limiting examples comprise a user equipment, a terminal device, a mobile station (MS) or mobile device such as a mobile phone or what is known as a ‘smart phone’, a computer provided with a wireless interface card or other wireless interface facility (e.g., USB dongle), a device using a wireless modem (alarm or measurement device, etc.), a personal data assistant (PDA) or a tablet provided with wireless communication capabilities, a machine-type communications (MTC) device, a Cellular Internet of things (CIoT) device or any combinations of these or the like. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

A communication device may provide, for example, communication of data for carrying communications such as voice, electronic mail (email), text message, multimedia, machine data and so on. Services may be provided via the communication devices. Non-limiting examples of these services comprise two-way or multi-way calls, data communication or multimedia services or simply an access to a data communications network system, such as the Internet. A user may also be provided broadcast or multicast data. Non-limiting examples of the content comprise downloads, television and radio programs, videos, advertisements, various alerts and other information.

The communications device is referred to as a UE in the following but it should be appreciated that any alternative communications device may be used instead of a UE. The UE 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The UE 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

An example of wireless communication systems are architectures standardized by the 3rd Generation Partnership Project (3GPP). The currently being developed 3GPP based development, is often referred to as the 5G or NR standards part of long term evolution (LTE) or LTE Advanced Pro of the Universal Mobile Telecommunications System (UMTS) radio-access technology. Other examples of radio access system comprise those provided by base stations of systems that are based on technologies such as wireless local area network (WLAN) and/or WiMAX (Worldwide Interoperability for Microwave Access). It should be understood that embodiments may also be used with later or different standards.

Some embodiments may be used in conjunction with NB-IoT/eMTC over non-terrestrial networks (NTN). This may be used in relation to release 18 work associated with the 5G standardization and beyond. This may of course be used with any other suitable standard. The release 18 work item (RP-220979) includes the following objective: 4.1.1 IoT-NTN Performance Enhancements in Rel-18 to address remaining issues from Rel-17

This work considers Rel-17 IoT-NTN as baseline as well as Rel-17 NR-NTN outcome and the further IoT-NTN performance enhancements objectives are listed below:
Disabling of HARQ feedback to mitigate impact of HARQ stalling on UE data rates
Study and specify, if needed, improved GNSS operations for a new position fix for UE pre-compensation during long connection times and for reduced power consumption. Simultaneous GNSS and NTN NB-IoT/eMTC operation is not assumed.

The UE may be required to utilize the GNSS for pre-compensating uplink transmissions for time and frequency errors. This may be required as the NTN scenario may rely on low-earth orbit (LEO) satellites. These satellites may move at a speed of 7.5 km/s relative to Earth, i.e. causing a rapidly varying time drift and Doppler shift.

For example, according to the TR 38.821 (NR NTN) a transparent LEO satellite at 600 km has a maximum round trip delay of 25.77 ms with a differential delay in a cell of 3.12 ms. Furthermore, the maximum Doppler shift is 24 ppm, while the Doppler shift variation is 0.27 ppm/s.

The LEO satellite movement is known because the satellites move in well-defined orbits. Therefore, the 3GPP has agreed that the network will provide information on satellite movement (ephemeris) to the UEs.

The UE, which is aware of its own location based on GNSS, may then utilize knowledge of the satellite position and movement to determine how an uplink transmission shall be adjusted for time and frequency drift.

However, IoT NTN devices are assumed to be simple and thus 3GPP has made the assumption that the UE cannot operate using GNSS and NTN IoT simultaneously.

In release 17 the following relevant agreements were made: RAN2 #116bis-e agreements:
The UE needs to have a valid GNSS fix before going to the connected mode. RAN2 assumes that the UE may need to re-acquire the GNSS fix right before establishing the connection (regardless if previously valid or not), if needed to avoid interruption during the connection.
When the GNSS fix becomes outdated in the RRC_CONNECTED mode, the UE goes to the IDLE mode.

RAN1 #107-e agreement:
The UE autonomously determines its GNSS validity duration X and reports information associated with this validity duration to the network via RRC signalling.
   X={10s, 20s, 30s, 40s, 50s, 60s, 5 min, 10 min, 15 min, 20 min, 25 min, 30 min, 60 min, 90 min, 120 min, infinity}

RAN1 #106-e agreement:
For sporadic short transmission, a UE in an RRC_CONNECTED mode should go back to the idle mode and re-acquire a GNSS position fix if GNSS becomes outdated.
Note: The duration of the short transmission is not longer than the “validity timer for UL synchronization” referred to in the WID objective (but which still needs further discussion for specifying further details)

The agreement for the UE to move to RRC Idle when the GNSS fix is outdated was acceptable in release 17, because the connection time was assumed to be short. However, the release 18 objective now considers longer connection times. Therefore, it may not be feasible for the UE to move to RRC Idle, because a data transfer may be interrupted and possibly not be resumable.

The envisioned UE behaviour during a long connection may be as follows:
1. The UE obtains a GNSS fix prior to connection setup (RAN2 agreement).
2. The GNSS validity timer is communicated with the network (RAN1 agreement).
3 The UE may need a new GNSS fix if the UE is moving/if the GNSS validity timer is about to expire.
4. For Connected UEs, the network needs to schedule GNSS measurement gaps.
5. Similar to transmission gaps during repetitions, the network needs to retain information on the ongoing transmission during the GNSS measurement gap.
6. After UE has re-acquired the GNSS fix, the network and the UE need to have a common understanding of this—for example was the acquisition successful?

Some embodiments may address the problem as to how the need for a new GNSS fix is detected. If the GNSS validity timer is accurately set, the NW may be aware of the imminent expiry and the NW can schedule a GNSS measurement gap accordingly. However, if the UE is moving, the GNSS validity timer may not be accurate. A challenge may be that the UE does not detect the movement, because the IE does not have a measurement gap allowing it to use the GNSS.

Some embodiments may provide network and UE means to perform such detection.

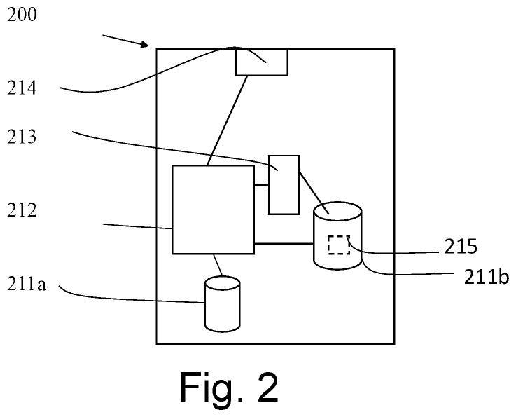

A UE location error, arising from UE movement since a last GNSS fix or inaccuracy of GNSS fix, may lead to an error in its timing advance (TA) estimate. The largest TA error may occur when the UE is in the satellite's ground traverse path and the location error direction is also aligned with the path. The UE location error impact on timing advance in this worst case is illustrated in FIG. 4. FIG. 4 shows a graph of UE location error in m again TA error in μs. The allowed timing error Te is 80 Ts for NB-IoT and 24 Ts for eMTC. Ts is a constant timing unit which is defined in the LTE specifications and maps directly to the values on the y-axis. Ts is defined in 36.211 as:
the size of various fields in the time domain is expressed as a number of time units Tₛ=1/(15000×2048) seconds.

Downlink, uplink and sidelink transmissions are organized into radio frames with T_{f}=307200×Tₛ=10 ms duration.

(Different standards may have different timing values. For example, in 5G, this timing value is referred to as Tc and has a value of 0.509 ns).

The timing error mentioned previously corresponds to a location error of 126 m and 38 m, respectively for an elevation angle of 10 degrees. Thus even small UE movement may impact the uplink timing. For example, an IoT device mounted on a container loaded on a truck moving with 80 km/h (22.2 m/s) will violate the timing requirement in 1.7 s and 5.7 s for eMTC and NB-IoT respectively. If the device is on a freight train it may move even faster

Some of the current arrangements do not address the scenario where the GNSS validity timer becomes invalid due to UE movement.

In current implementations the (terrestrial) network will monitor if the UE's uplink transmission is not aligned and then issue a TA command. The misalignment can be determined by the base station in the channel estimation process from the UE's reference signal. However, the (terrestrial) network will not be aware of the UE's location & movement and will not take into account the changing propagation delay. This may also be done for NTN and the network can send TA commands. However when the UE reads the GNSS, it will likely reset the previous TA commands, which may cause some jumps. Some embodiments may reduce or avoid these jumps.

Some embodiments may provide one or more methods to determine that the UE's GNSS position is valid or invalid and needs to be updated or can be continuously reused. Some embodiments may use the predictable satellite movement and that the UE shares its valid location with the network at least once.

In some embodiments, one or more of the following may be provided.

1. The network obtains the UE location and schedules uplink transmission(s).

2. The network monitors the UE's uplink transmission and detects any time/frequency drift, which is not in line with expectations. The network may check if the frequency and/or timing differs from an expected frequency and/or timing.

3. If the time and/or frequency drift exceeds a threshold, the network schedules a GNSS measurement gap. The network may check if the frequency and/or timing differs from an expected frequency and/or timing by a threshold amount.

In some embodiments, the network may optionally order the UE to stop any ongoing transmissions.

If the time/frequency drift is as expected the network may indicate to the UE to restart the GNSS validity timer without performing a GNSS fix.

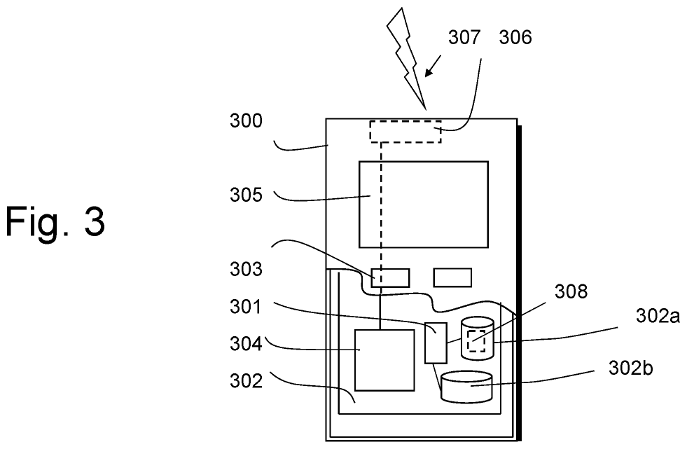

Reference is made to FIG. 5 which illustrates the signalling between a UE and the network according to some embodiments. The signal flow of FIG. 5 shows the case where the UE needs a fix.

In S1, the UE receives satellite ephemeris from the network.

In S2, the network receives UE location information from the UE.

In S3, the UE receives a schedule for uplink transmission from the network.

In S4, the network estimates when the UE transmissions are expected to be received.

In S5, the UE transmits uplink transmissions to the network.

In S6, the network determines that the transmission drift is within a threshold.

In S7, the UE transmits uplink transmissions to the network.

In S8, the network determines that the transmission drift exceeds the threshold.

In S9, the network indicates to the UE a scheduled GNSS measurement gap. Optionally, the UE is ordered to stop uplink communications. This may be until the UE has reacquired a valid position.

In S10, the UE obtains a new GNSS location fix.

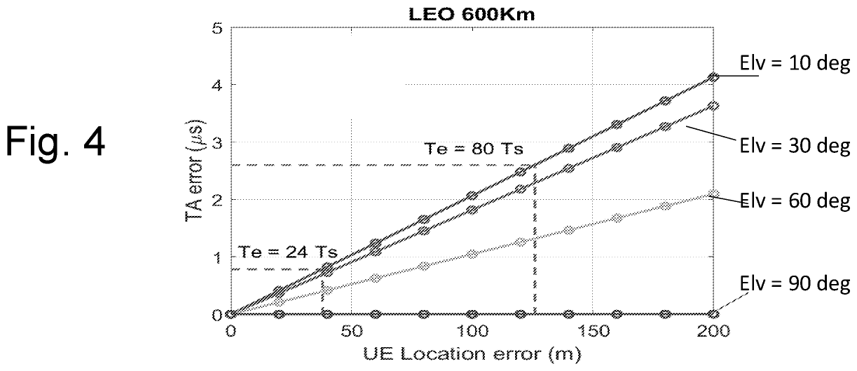

Reference is made to FIG. 6 which shows a method flow of some embodiments.

As referenced T1, the RAN is monitoring the uplink timing and frequency of transmissions from the UE.

As referenced T2, the RAN determines if the timing and/or frequency are as expected. As RAN knows the UE location, the satellite ephemeris and the common delay, the RAN can calculate the expected values. A small margin can be applied to cover for other errors, for example the UE clock and/or the like. If the timing and/or frequency are as expected, this is followed by T3.

As referenced T3, it is checked if the GNSS validity timer of the UE is close to expiration. For example, a check may be made to see if there is less than a threshold amount of time remaining. If there is less than a threshold amount of time remaining, it may be determined that the validity timer is close to expiring. This may be performed by the RAN. Alternatively or additionally, this may be done in the UE. If the timer is not close to expiring, then the method reverts to T1. If the timer is close to expiring, then this is followed by T4. As referenced T4, if the GNSS validity timer is close to expiring, but the timing and/or frequency (for example as determined in T2) indicate the UE has not moved, the network signals to the UE that the UE can restart its GNSS validity timer without a GNSS fix. This signalling may be done by MAC-CE signalling or in any other suitable way. In some embodiments, the timer may be restarted with the same value. Alternatively, the UE may use a different validity timer value. This may be based on the elevation angle with the serving NTN satellite. For example, when the serving satellite (i.e., the satellite providing connectivity to the UE in NTN) is at a high elevation angle, larger UE location errors may be tolerated as shown in FIG. 4, so the validity timer value can be relaxed in that situation. (The NTN satellites are different in this example to the GNSS satellites). Alternatively or additionally, this may be based on a different value provided by the network. A larger value may be used if the UE is stationary. Alternatively or additionally, the timer value may be based on a pre-programmed table with values.

One metric for the NW may be to check whether the timer will expire before a “soon to be scheduled” uplink transmission is finished. Uplink transmissions can last seconds and even 10s of seconds in IoT LTE because of the use of repetitions. The “soon to be scheduled” may be the time from the NW receiving a buffer status report from the UE indicating the need for uplink transmission and until NW has made the scheduling decision. This may be used to determine if the GNSS time is close to expiring.

Alternatively or additionally, close to expiring may for example be when at least 90% (or other suitable value) of the timer has expired

If it is determined in T2 that the timing and/or frequency values are not as expected, then this is followed by T5. As referenced T5, it is checked if the changes in timing and/and frequency are such that they will exceed acceptable maximum values before the GNSS validity timer expires. If not, then this is followed by T1. If so, then this is followed by T6.

As referenced T6, the network schedules a GNSS gap and informs the UE such the UE can update the GNSS fix.

Some embodiments may have one or more of the advantages:

Detecting UE location error and scheduling GNSS measurement gaps enables the network and UE to avoid misaligned uplink transmissions. This may mean interference is reduced.

Network-based detection of UE location error may be useful for IoT NTN, where the UE does not operate GNSS and IoT simultaneously.

Avoiding GNSS reading if it is not needed.

Thus some embodiments allow the monitoring and detection of uplink misalignment by the network. The network may take one or more of the following into account when determining whether the UE's uplink transmission is actually misaligned:
A. UE's reported location
B. Satellite movement leading to a changing propagation delay between the satellite and UE location
C. Drift caused by inaccuracies in the ephemeris. The ephemeris is determined for a certain Epoch time after which the actual satellite location and ephemeris-based predicted location will drift apart
D. Past TA commands the network has sent.
E. UE trajectory/movement if it is known.
F. TA common, indicating the feeder link delay TA_common represents the feeder link delay which the UE is compensating for as well as based on information broadcasted by the network.
G. GNSS validity timer

The indication of “good time alignment” from the network to the UE, as for example determined in T2, may be provided via one or more of the following:
A bit indicator in DCI (either with a new UL allocation or DCI with other DL contents). There may also be an indication that the time alignment timer is to be restarted.
A MAC-CE with a timing advance command with net value equal to 0. In this case, with this feature, the UE will interpret the MAC-CE command as an indication of good timing alignment. The UE may, in response to that MAC-CE command postpone, restart and/or extend the validity timer.

When the UE receives the “good time alignment indication”, the UE may perform one or more of the following:
The UE may restart the validity timer (for example starting it from 0 again)
The UE may increment the expiration value for the timer by a fixed value. This may be for example specified in a standard and/or be indicated by the gNB. Alternatively, there may be a set of values and the UE may increment to the next or previous value in the set of values. The gNB may indicate if the next value is to be used. This may alternatively be known by the UE based, for example, on the time since the last scheduling of the gap.
UE may use set a higher baseline (that is a longer period of time) for the validity timer for the next occasion, i.e., after the UE updates its position.

In some embodiments, a UE make take one or more of the following actions after receiving a “measurement gap” order:
If the measurement gap order is indicated to UE earlier (by a time X) compared to the validity timer: UE may decrease the expiration value of the validity timer for the next iteration. The expiration value time may be decreased by a fixed amount or by a value which is dependent on time X.
If the UE receives several MAC-CE with Timing Advance commands different from 0, or if the total value of MAC-CE commands are greater than a set threshold, the UE may also decrease the expiration value of the timer for the next iteration.

In an alternative embodiment, the timing misalignment detection may be performed by the UE as follows:

The UE receives TA commands which are not in line with the UE's original location, when considering one or more of the parameters A-D above.

The UE compares the timing of PSS and/or SSS in transmission gaps (and/or any other DL signalling with known timing) with the GNSS-based time and determines if there is difference between when the PSS and/or SSS and/or other DL signal was expected and when it actually was received.

If the UE detects an issue, the UE can request a GNSS measurement gap.

Thus some embodiments may relate to the behaviour of the network entity such as a gNB or the like. This may enable the transmission to the UE of GNSS measurements gaps that can be used in order to perform a GNSS fix (that is determine a location of the communications device based on satellite positioning data.

Some embodiments may be performed in NTN networks with UEs which cannot operate GNSS and 3GPP (or other cellular network) simultaneously. The network-based mechanism may allow GNSS measurement gaps when the position data associated with the UE becomes invalid. The network (for example the gNodeB) checks if the position is still valid (via TA) and schedules GNSS measurement gaps when needed. Thus the RAN knows the UE position and the satellite position so knows what the TA values should be. If not the same, the UE is using a different GNSS position (either due to movement or due to an erroneous GNSS fix) Some embodiments enable the network to schedule GNSS measurement gaps when the UE's transmission is aligned/not aligned in time and/or frequency. The NW monitors the UE's uplink transmission and detects the time and/or frequency drift to decide whether the GNSS position data is still valid for the UE. If the position data is not still valid, the NW may schedule a measurement gap for GNSS re-acquisition. If the position data is still valid, then the NW asks the UE to reset the GNSS validity timer. The time/frequency being monitored refers to how well aligned the UE's uplink transmission (PUSCH, PUCCH, SRS, etc) is with the time-frequency resources (symbol in time, subcarrier in frequency).

So for example, NW may notice a symbol arrives a bit too early/late compared to the receiver's symbol timing Likewise the network may notice that the subcarriers of the transmitted signal are not completely aligned with the receiver.

Frequency drift may however show up at the satellite, and the satellite may convert it for feeder link conversion, so the frequency drift information may not be available in RAN for the transparent case. However, in other embodiments, frequency drift information may be used.

The UE may be required to utilize the GNSS for pre-compensating uplink transmissions for time and/or frequency errors. This may be necessary because NTN may rely on low-earth orbit (LEO) satellites as discussed previously. These satellites move with 7.5 km/s relative to Earth, i.e. causing a rapidly varying time drift and Doppler shift. The transparent LEO satellite at 600 km will have a maximum round trip delay of 25.77 ms with a differential delay in a cell of 3.12 ms. Furthermore, the maximum Doppler shift is 24 ppm, while the Doppler shift variation is 0.27 ppm/s. The LEO satellite movement is known because the satellites move in well-defined orbits. Therefore, the network will provide information on satellite movement (ephemeris) to the UEs. The UE, which is aware of its own location based on GNSS, can then utilize knowledge of the satellite position and movement to determine how an uplink transmission shall be adjusted for time and/or frequency drift. IoT NTN devices may be simple and may not be able to operate the GNSS and NTN IoT simultaneously.

If the GNSS validity timer is accurately set the NW is aware of the imminent expiry and the NW can schedule a GNSS measurement gap accordingly. However, if the UE is moving the GNSS validity timer may not be accurate. The challenge is that the UE cannot detect the movement because it does not have a measurement gap allowing it to use the GNSS. Some embodiments propose network and/or UE means to perform such detection. UE location error, arising from UE movement since last GNSS fix or inaccuracy of GNSS fix, may lead to an error in its timing advance (TA) estimate.

Some embodiments provide methods to determine that the UE's GNSS position is valid or invalid and if it needs to be updated or can be continuously reused. Some embodiments use the predictable satellite movement and the UE sharing its valid location with the network at least once. The network may obtain the UE location and schedules uplink transmissions. The network may monitor the UE's uplink transmission and detects any time and/or frequency drift, which is not in line with the expectation. If the time and/or frequency drift exceeds a threshold the network may schedule a GNSS measurement gap. The network may optionally also order the UE to stop any ongoing transmissions. If the time/frequency drift is as expected the network may indicate to the UE to restart the GNSS validity timer without performing a GNSS fix.

The advantages of some embodiments are detecting UE location errors, and scheduling GNSS measurement gaps enables the network and UE to avoid misaligned uplink transmissions i.e. interference is reduced. Network-based detection of UE location error may be particularly useful for IoT NTN, where the UE cannot operate GNSS and IoT simultaneously. Some embodiments may avoid GNSS reading if it is not needed.

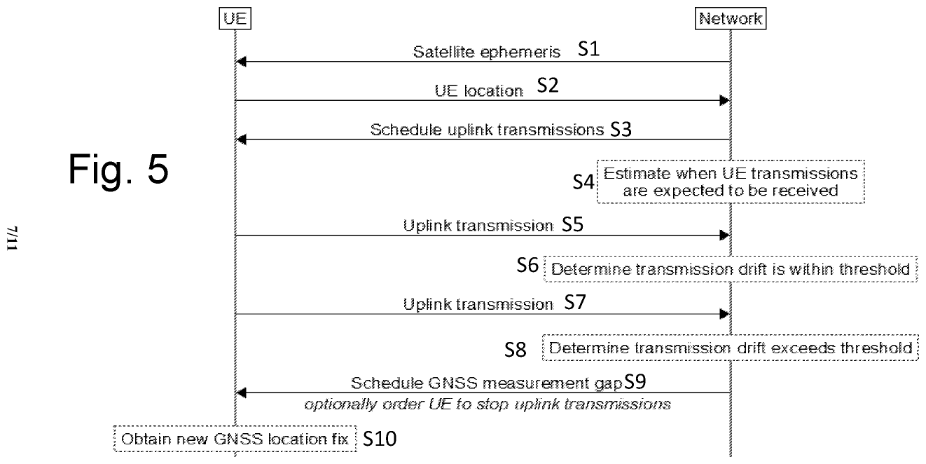

A method of some embodiments will now be described with reference to FIG. 7. The method may be performed by an apparatus. The apparatus may, for example, be as shown in FIG. 2. The apparatus may be a base station, a part of a base station or provided in a base station. The base station may be a gNB or the like. The apparatus may alternatively be provided in or be any other suitable network entity.

In A1, the method comprises monitoring uplink transmissions from a communications device to determine if the frequency and/or timing of the uplink transmissions are as expected.

In A2, the method comprises scheduling for the communications device a position acquisition gap when the frequency and/or timing of the uplink transmissions are not as expected.

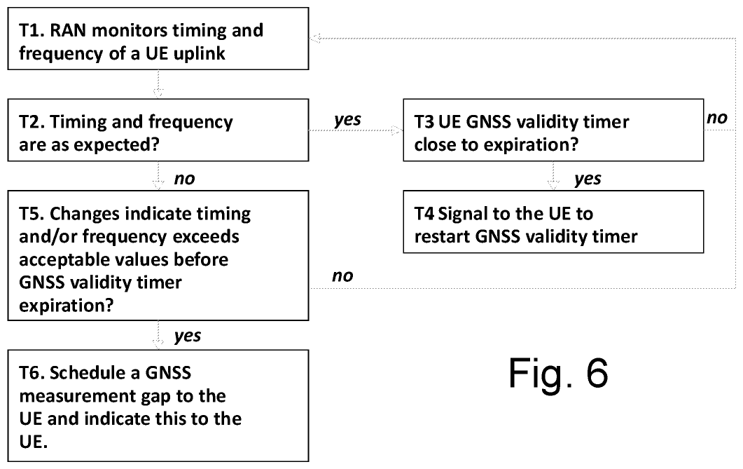

A method of some embodiments will now be described with reference to FIG. 8. The method may be performed by an apparatus. The apparatus may, for example, be as shown in FIG. 2. The apparatus may be a base station, a part of a base station or provided in a base station. The base station may be a gNB or the like. The apparatus may alternatively be provided in or be any other suitable network entity.

In B1, the method comprises monitoring uplink transmissions from a communications device to determine if the frequency and/or timing of the uplink transmissions are as expected.

In B2, the method comprises determining that a position acquisition validity timer associated with the communications device is to expire.

In B3, the method comprises when it is determined the frequency and/or timing of the uplink transmissions are as expected and when it is determined that the position acquisition validity timer associated with the communications device is to expire, causing a message to be sent to the communications device indicating that the position acquisition validity timer associated with the communications device is to be restarted without performing a position acquisition fix.

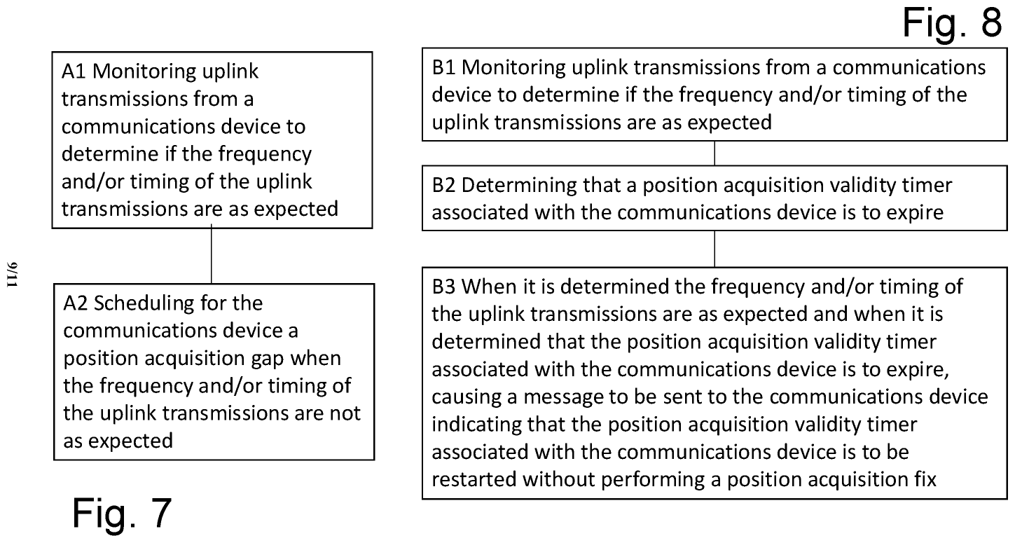

A method of some embodiments will now be described with reference to FIG. 9. The method may be performed by an apparatus. The apparatus may, for example, be as shown in FIG. 2 and/or FIG. 3. The apparatus may be provided in a communications device or be a communications device.

In C1, the method comprise receiving from a network apparatus a message indicating that a position acquisition validity timer associated with a communications device is to be restarted without performing a position acquisition fix.

In C2, the method comprises restarting the position acquisition validity timer without performing a position acquisition fix.

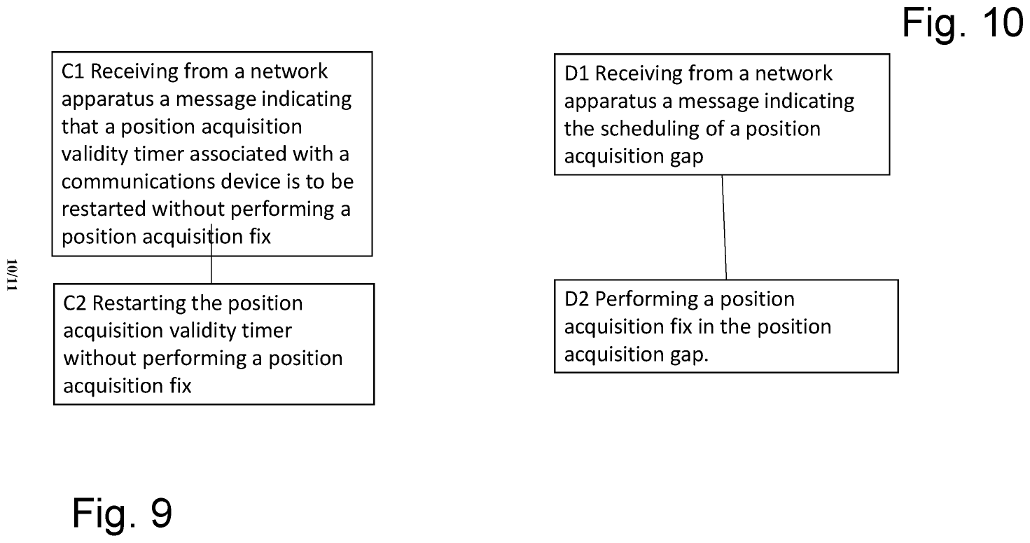

A method of some embodiments will now be described with reference to FIG. 10. The method may be performed by an apparatus. The apparatus may, for example, be as shown in FIG. 2 and/or FIG. 3. The apparatus may be provided in a communications device or be a communications device.

In D1, the method comprises receiving from a network apparatus a message m indicating the scheduling of a position acquisition gap.

In D2, the method comprises performing a position acquisition fix in the position acquisition gap.

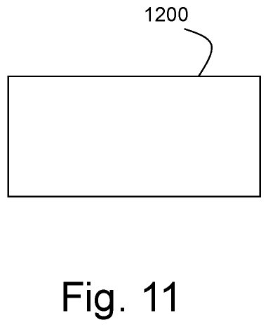

FIG. 11 shows a schematic representation of non-volatile memory media storing instructions and/or parameters which when executed by a processor allow the processor to perform one or more of the steps of the methods of FIGS. 6 to 10.

It is noted that while the above describes example embodiments, there are several variations and modifications which may be made to the disclosed solution without departing from the scope of the present invention.

Reference has been made to GNSS positioning and GNSS measurement gaps. In other embodiments, other position acquisition techniques may be used. By way of example only, the position acquisition technique may be a network-based or network-verified position technique. A position acquisition gap may be provided with the network-based or network-verified position technique.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 6 to 10, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1.-22. (canceled)

23. An apparatus comprising at least one processor and at least one memory including computer code, wherein the at least one memory and the computer code are configured, with the at least one processor, to cause the apparatus to:
monitor uplink transmissions from a communications device to determine if the frequency and/or timing of the uplink transmissions are as expected;
determine that a position acquisition validity timer associated with the communications device is to expire; and
when it is determined the frequency and/or timing of the uplink transmissions are as expected and when it is determined that the position acquisition validity timer associated with the communications device is to expire, send a message to the communications device indicating that the position acquisition validity timer associated with the communications device is to be restarted without performing a position acquisition fix.

24. The apparatus as claimed in claim 23, wherein the message further comprises information indicating a new timing value for the position acquisition validity timer.

25. An apparatus comprising at least one processor and at least one memory including computer code, wherein the at least one memory and the computer code are configured, with the at least one processor, to cause the apparatus to:
receive, from a network apparatus, a message indicating that a position acquisition validity timer associated with the apparatus is to be restarted without performing a position acquisition fix; and
restart the position acquisition validity timer without performing a position acquisition fix.

26. The apparatus as claimed in claim 25, wherein the apparatus is further caused to:
transmit information to the network apparatus indicating a timing value which is being used for the restarted validity timer.

27. The apparatus as claimed in claim 25, wherein restarting the position acquisition validity timer restarts the validity timer with a different timing value compared to a previous timing value.

28. The apparatus as claimed in claim 27, wherein the apparatus is further caused to:
determine the different timing value in dependence on an elevation angle associated with a serving satellite of a non-terrestrial network.

29. The apparatus as claimed in claim 27, wherein the apparatus is further caused to:
determine the different timing value based on a table of values stored in said apparatus.

30. The apparatus as claimed in claim 27, wherein the apparatus is further caused to:
determine the different timing value by incrementing the previous timing value by a fixed value to provide the different timing value.

31. The apparatus as claimed in claim 27, wherein the apparatus is further caused to:
determine the different timing value by selecting a next value in a set of timing values.

32. The apparatus as claimed in claim 27, wherein information about the different timing value is provided by the network apparatus.

33. A method comprising:
receiving, from a network apparatus, a message indicating that a position acquisition validity timer associated with a communications device is to be restarted without performing a position acquisition fix; and
restarting the position acquisition validity timer without performing a position acquisition fix.

34. The method as claimed in claim 33, further comprising:
transmitting information to the network apparatus indicating a timing value which is being used for the restarted validity timer.

35. The method as claimed in claim 33, wherein restarting the position acquisition validity timer restarts the validity timer with a different timing value compared to a previous timing value.

36. The method as claimed in claim 35, further comprising:
determining the different timing value in dependence on an elevation angle associated with a serving satellite of a non-terrestrial network.

37. The method as claimed in claim 35, further comprising:
determining the different timing value based on a table of values stored in said apparatus.

38. The method as claimed in claim 35, further comprising:
determining the different timing value by incrementing the previous timing value by a fixed value to provide the different timing value.

39. The method as claimed in claim 35, further comprising:
determining the different timing value by selecting a next value in a set of timing values.

40. The method as claimed in claim 35, wherein information about the different timing value is provided by the network apparatus.
